(19) United States
(12) Patent Application Publication
(10) Pub. No.: US 2009/0240824 A1
(43) Pub. Date: Sep. 24, 2009

(54) UDP Hole Punch Timeout Discovery Algorithm Over Network Address Translation Connection

(76) Inventor: Boris Rekhtman, Bethesda, MD (US)

Correspondence Address: THE LAW OFFICE OF JOHN T. WHELAN, L.L.C., 135 WEST DARES BEACH ROAD, SUITE 204, PRINCE FREDERICK, MD, 20678, US

(21) Appl. No.: 12/402,153

(22) Filed: Mar. 11, 2009

Related U.S. Application Data
(60) Provisional application No. 61/035,601, filed on Mar. 11, 2008.

(51) Int. Cl. G06F 15/16

(52) U.S. Cl. 709/230

(57) ABSTRACT

A method is provided for communicating between a server and a client via a network address translator. The server is in communication with the network address translator via a first channel. The client is in communication with the network address translator via a second channel. The method includes performing a universal datagram protocol hole punch through the network address translator, sending an acknowledgment request from the client, receiving the acknowledgment request at the server and sending an acknowledgment. The universal datagram protocol hole punch the first channel with the second channel. The acknowledgment request includes information based on a predetermined period of time. The server sends the acknowledgement after delaying for the predetermined period of time, wherein the acknowledgment is based on the acknowledgment request.

The present application claims benefit under 35 U.S.C. § 119 (e) to U.S. provisional patent application 61/035,601, filed Mar. 11, 2008, the entire disclosure of which is incorporated herein by reference.

### BACKGROUND

A User Datagram Protocol (UDP) is a set of network protocols used for the Internet. With UDP, computer applications can send messages, i.e., datagrams, to other hosts on an Internet Protocol (IP) network without requiring prior communications to set up special transmission channels or data paths. IP has the task of delivering distinguished protocol datagrams (packets) from the source host to the destination host solely based on their address.

FIG. 1 illustrates a simplified IP communication system. As illustrated, system 100 includes a server 102, a local network 104 and an IP network 106. Local network 104 includes a client 108, a client 110, a client 112 and a Network Address Translation (NAT) router 114. Server 102 is arranged to communicate with IP network 106 via channel 116. Each of client 108, client 110 and client 112 are arranged to communicate with one another via channels 118. Client 108 is arranged to communicate with NAT router 114 via channel 120. Client 110 is arranged to communicate with NAT router 114 via channel 122. Client 112 is arranged to communicate with NAT router 114 via channel 124. NAT router is arranged to communicate with IP network 106 via channel 126.

Server 102 has a unique IP address that is used by IP network 106 to identify datagrams originating from server 102 and to identify datagrams that are to be transmitted to server 102.

NAT router 114 has a unique IP address that is used by IP network 106 to identify datagrams originating NAT router 114 and to identify datagrams that are to be transmitted to NAT router 114. The IP address NAT router 114 is typically used for communications from any of client 108, client 110 and client 112 to an IP address outside of local network 104 and for communications to any of client 108, client 106 and client 108 from an IP address outside of local network 104. The function of NAT router 114 may initially be described by way of an analogy below.

Presume that Company has workers Boris, Bill and Kamran and a mailroom attendant John. Each of Boris, Bill and Kamran has their own respective office within Company. John works in the mail room. Boris, Bill and Kamran may deliver letters to each other's offices without routing such letters through John in the mail room.

Presume, in this analogy, that Boris wants to send a letter to a recipient, Dave, outside of Company. In this case, the letter is first sent to John in the mail room. At this point, John sends out the letter to Dave, and identifies on the letter the address of Company as the sender's address and identifies Boris as the sender. In this situation, when Dave receives the letter, he knows that the letter is from Boris, but thinks that Boris' address is the address of the Company. When Dave sends a reply letter to Boris, it is addressed to Company. Upon receipt of the letter in the mailroom of Company, John determines that the letter is to be delivered to Boris and promptly delivers the letter directly to Boris' office.

Similar to John in the mailroom discussed above, NAT router 114 translates local network addresses for clients within local network 104, which in this example includes client 108, client 110 and client 112, for communications outside of local network 104. Each of client 108, client 110 and client 112 has a respective unique IP address that is used by NAT router 114 to identify datagrams originating from each of client 108, client 110 and client 112, respectively, and to identify datagrams that are to be transmitted to each of client 108, client 110 and client 112, respectively. By using the IP addresses, NAT router 114 is operable to provide datagrams from each of client 108, client 110 and client 112 to server 102 via IP network 106. Similarly, by using the IP addresses, NAT router 114 is operable to provide datagrams from server 102 to each of client 108, client 110 and client 112 via IP network 106.

In this discussion, server 102 is called a “server” to provide a simplified example, where data is generally being provided by server 102 to at least one of client 108, client 110 and client 112. Of course server 102 may have been referred to as a “sender” or “transmitter,” whereas each of client 108, client 110 and client 112 may have been referred to as a “receiver.” However, in such a case, to be accurate, each of client 108, client 110 and client 112 may then have needed to be referred to as a “sender” or “transmitter” when sending data to server 102. Similarly, in such a case, server 102, when receiving data, may have needed to be referred to as a “receiver.” Accordingly, to simplify the discussion, in this example, the terms “server” and “client” are used. In should be noted that in other circumstances, any of client 108, client 110 and client 112 may be a “server” and server 102 may be a “client.”

Examples of schemes for routing datagrams in accordance with IP communication system 100 include a broadcast routing scheme, a multicast routing scheme and a unicast routing scheme.

In a broadcast routing scheme, server 102 sends datagrams to each of client 108, client 110 and client 112. In this scheme, server 102 sends datagrams to NAT router 114. NAT router 114 recognizes, for example based on data within the datagrams, that the datagrams are to be delivered to each of client 108, client 110 and client 112. NAT router 114 then delivers a copy of the datagrams to each of client 108, client 110 and client 112.

In a multicast routing scheme, server 102 sends datagrams to some of client 108, client 110 and client 112. As an example, in this scheme, presume server 102 desires to send datagrams to client 108 and client 112, but not to client 110. In this case, server 102 sends datagrams to NAT router 114. NAT router 114 recognizes, for example based on data within the datagrams, that the datagrams are to be delivered to client 108 and to client 112. NAT router 114 then delivers a copy of the datagrams to client 108 and to client 112.

In a unicast routing scheme, server 102 sends datagrams to one of client 108, client 110 and client 112. As an example, in this scheme, presume server 102 desires to send datagrams client 112, but not to client 108 and not to client 110. In this case, server 102 sends datagrams to NAT router 114. NAT router 114 recognizes, for example based on data within the datagrams, that the datagrams are to be delivered to client 112 only. NAT router 114 then delivers the datagrams to client 112 only. The unicast routing scheme will now be described in greater detail.

Suppose that client 112 desires to set up a unicast routing scheme with server 102, wherein data will be shared between only server 102 and client 112, i.e., client 108 and client 110 will not be privy the data. In this case, data packets will travel back and forth between server 102 and client 112 through IP network 106. Specifically, data packets from client 112 may travel through channel 124 to NAT router 114. From NAT router 114, the data packets may travel through channel 126 to IP network 106. From IP network 106, the data packets may travel through channel 116 to server 102. A reverse path will be traversed for data packets from server 102 to client 112.

An example conventional process of performing an unicast routing scheme will now be discussed with additional reference to FIG. 2.

FIG. 2 illustrates a conventional process 200 of communicating between sender 102 and client 112 in a unicast routing scheme.

After process 200 starts (S202), client 112 must initialize direct communication with server 102 by “punching a hole” through NAT router 114 (S204). In an example embodiment, client 112 sends a UDP registration packet to server 102 via channel 124, NAT router 114 and channel 126. “Punching a hole” or providing a “Hole Punch,” may easily be described by way of analogy.

Specifically, consider NAT router 114 to be analogous to an opaque gelatinous block. Consider a person wanting to create a direct communication channel through NAT router 114 to be analogous to a person wanting to see through the opaque gelatinous block. In the situation of NAT router 114, client 112 sends a UDP registration packet to NAT router 114. In the analogous situation, the person may push a rod into one side of the opaque gelatinous block, continue to push the rod through the opaque gelatinous block and then pull the rod out of the other side of the opaque gelatinous block. In the situation of NAT router 114, the UDP registration packet, inter alia, instructs NAT router 114 to create a direct communication channel between channel 124 and channel 126. In the analogous situation, the person may see through the opaque gelatinous block by way of the newly created hole.

After the hole is punched in NAT router 114, server 102 receives the UDP registration packet and starts sending datagrams to client 112 via the punched hole in NAT router 114. Client 112 waits a predetermined period to time (S206).

Client 112 then determines whether any datagrams are received from server 102 (S208). If client 112 fails to receive a datagram from server 102, then client 112 again sends a UDP registration packet to NAT router 114 (S204).

If client 112 receives a datagram from server 102, then client 112 determines whether the received datagram is the last datagram sent by the server, and thus is the end of the unicast (S210). This determination may be performed by any known method, such as for example, examining data in the header of the packet of the datagram.

If indeed, it is determined that the received datagram is the last datagram sent by server 102, then process 200 stops (S216).

Alternatively, if at step S210, it is determined that the received datagram is not the last datagram sent by server 102, then receiver 112 determines whether a “KEEP ALIVE” period has nearly expired (S212). The “KEEP ALIVE” period may be generally explained with a return to the analogy of the opaque gelatinous block discussed above.

Returning back to the opaque gelatinous block having a hole therethrough to permit a person to look through the opaque gelatinous block. In the situation of NAT router 114, a direct communication channel had been created between channel 124 and channel 126. In the analogy, presume that the gelatinous block has a specific physical property that enables self closure of a through hole after a specific period of time. In the situation of NAT router 114, a direct communication channel created with a UDP hole punch typically must have a predetermined amount of allocated bandwidth. Such allocated bandwidth may not always be needed, for example if client 112 no longer needs the direct communication channel, i.e., client 112 is no longer “Alive.” If the bandwidth of NAT router 114 that is allocated for the direct communication channel is not being used, then such bandwidth of NAT router 114 is being wasted. Therefore, in order maximize efficiency, NAT router 114 will be operable to close such a UDP punched hole after a predetermined period of time. This predetermined period of time is called a UDP hole punch timeout period.

If it is determined that the KEEP ALIVE time period has not nearly expired, then process 200 again waits a predetermined period of time (S206).

Alternatively, if at step S212, it is determined that the KEEP ALIVE time period has nearly expired, then receiver 112 sends a KEEP ALIVE packet to NAT router 114 (S214). The sending of a KEEP ALIVE packet may be generally explained with a return to the analogy of the opaque gelatinous block.

Returning back to the opaque gelatinous block having a hole almost closed being analogous to NAT router 114 being about to close the UDP punched hole in order to reclaim the allocated bandwidth. In the situation of the opaque gelatinous block, in order for the person to continue to see through hole, the person must again push the rod into the throughhole to re-open throughhole for another predetermined period of time. In the case of NAT router 114, receiver 112 sends the KEEP ALIVE packet to NAT router 114. Among other things, the KEEP ALIVE packet instructs NAT router 114 not to close the UDP punched hole, even though server 102 has not sent any datagram within the last (almost entire) predetermined KEEP ALIVE time period.

After receiver 112 sends the KEEP ALIVE packet to NAT router 114, process 200 returns to step S206.

A breakdown in the above discussed analogy is additionally a problem associated with the conventional unicast process. Specifically, in the situation of the opaque gelatinous block, the person may easily see when the hole is about to close. At this time the person may push the rod through the opaque gelatinous block to re-open the hole. On the contrary, in the situation of NAT router 114, receiver 112 does not know when NAT router 114 is about to close the USP punched hole. That is, receiver 112 does not know the USP hole punch timeout period of NAT router 114. As such, in the conventional unicast process, receiver 112 must send the KEEP ALIVE messages at predetermined intervals, irrespective of whether such messages are required. Sending such messages, when not required reduces the efficiency of the process.

Returning back to the analogy, in the situation of the opaque gelatinous block, whenever the person is pushing the rod into the throughhole, the person cannot see through the throughhole, because the rod is there. Similarly, in the case of sending KEEP ALIVE packets, when receiver 112 is sending a KEEP ALIVE packet it cannot be receiving a datagram from server 102. Further, when NAT router 114 is processing a KEEP ALIVE packet, it is further limiting its resources.

In a conventional unicast routing scheme, the predetermined period for sending KEEP ALIVE messages maintain a NAT hole is typically on the order of 10 seconds, which is very inefficient in cases where the UDP hole punch timeout period is much greater than 10 seconds.

What is needed is an efficient method of maintaining a NAT hole in a unicast routing scheme.

### BRIEF SUMMARY

It is an object of the present invention to provide a system and method for efficiently maintaining a NAT hole in a unicast routing scheme.

In accordance with an aspect of the present invention, a method is provided for communicating between a server and a client via a network address translator. The server is in communication with the network address translator via a first channel. The client is in communication with the network address translator via a second channel. The method includes performing a universal datagram protocol hole punch through the network address translator, sending an acknowledgment request from the client, receiving the acknowledgment request at the server and sending an acknowledgment. The universal datagram protocol hole punch the first channel with the second channel. The acknowledgment request includes information based on a predetermined period of time. The server sends the acknowledgement after delaying for the predetermined period of time, wherein the acknowledgment is based on the acknowledgment request.

Additional objects, advantages and novel features of the invention are set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIG. 1 illustrates a simplified IP communication system;

FIG. 2 illustrates a conventional process of communicating between a sender and a client in a unicast routing scheme;

FIG. 3 illustrates an example client communication process in a unicast routing scheme in accordance with an aspect of the present invention;

FIG. 4 illustrates an example server communication process in a unicast routing scheme in accordance with an aspect of the present invention; and

FIG. 5 is a timing diagram for the processes of FIGS. 3 and 4.

### DETAILED DESCRIPTION

In accordance with an aspect of the present invention, a receiver may dynamically measure a NAT UDP hole punch timeout period, by using an internal discovery algorithm, to determine the optimum time between UDP registration packets to prevent the NAT connection from closing. In an example embodiment, the internal discovery algorithm is based on UDP probing with incremental delays. In specific embodiments, the internal discovery algorithm is initiated by the receiver and may require the sender's support.

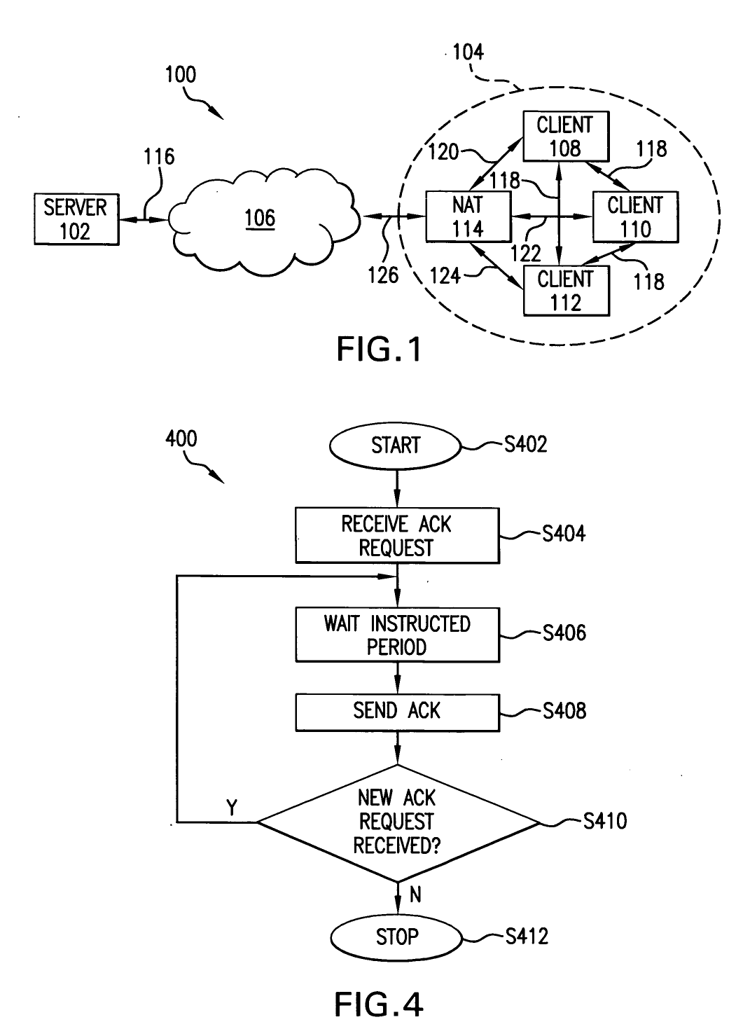

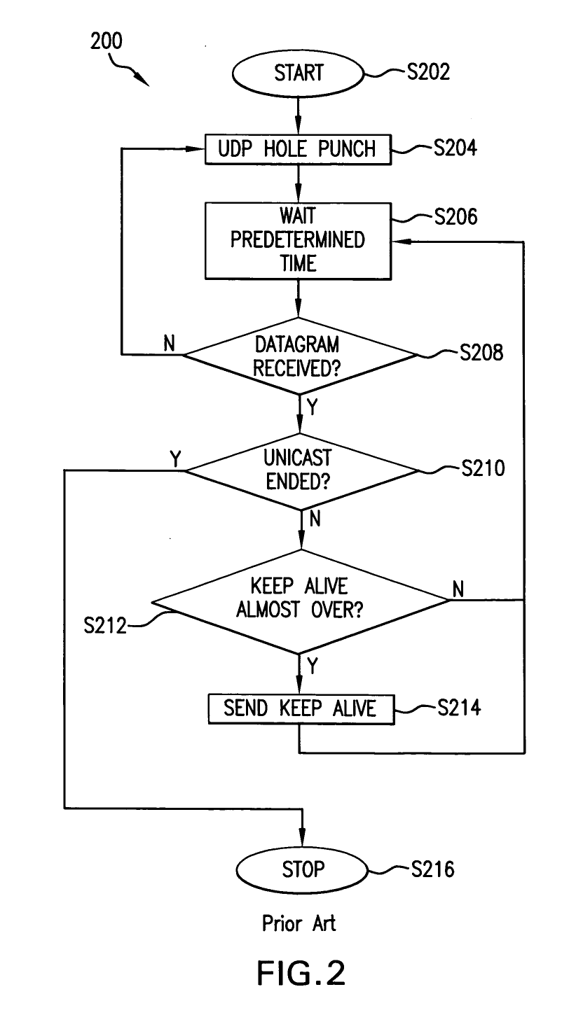

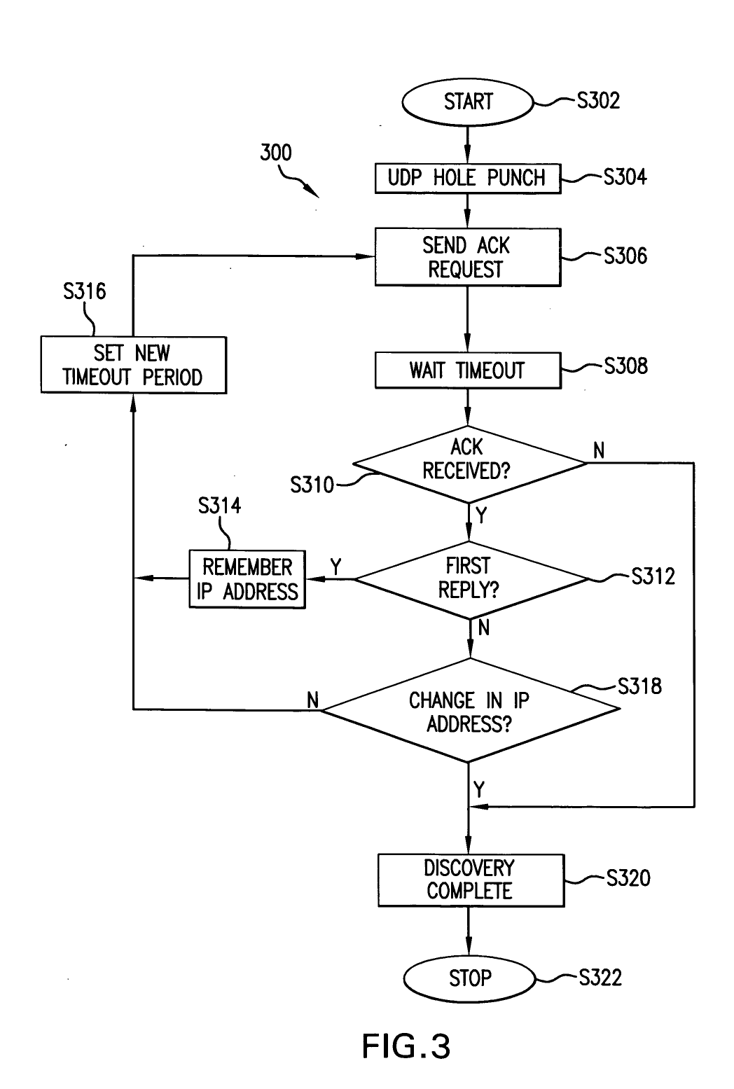

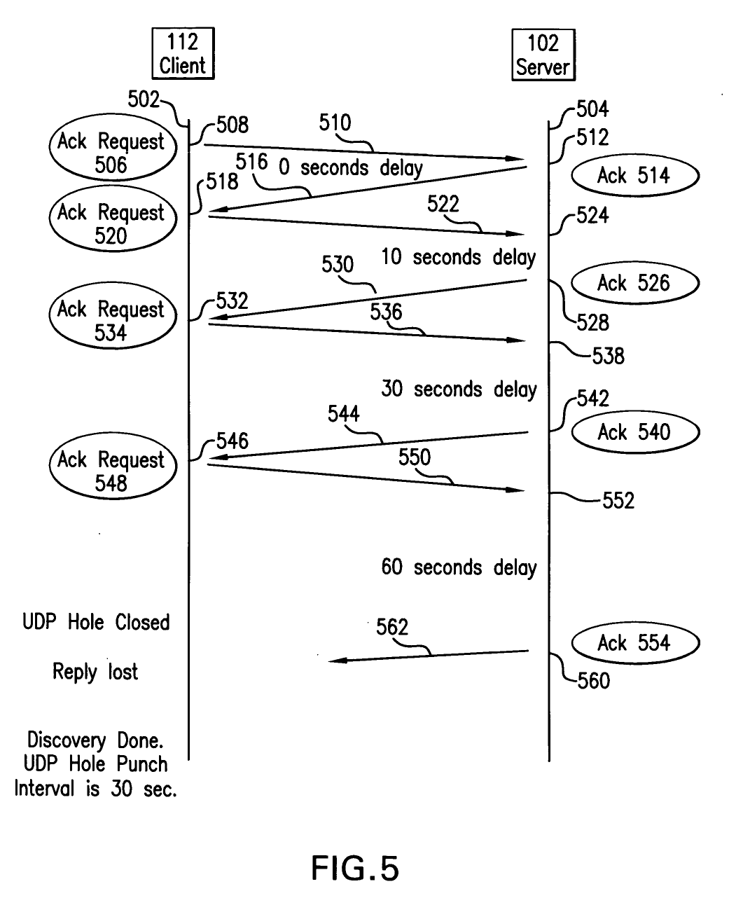

An example communication process in a unicast routing scheme in accordance with an aspect of the present invention will now be described with reference to FIG. 1 and FIGS. 3-5. FIG. 3 illustrates an example client communication process 300 in a unicast routing scheme in accordance with an aspect of the present invention. FIG. 4 illustrates an example server communication process 400 in a unicast routing scheme in accordance with an aspect of the present invention. FIG. 5 is a timing diagram for the processes of FIGS. 3 and 4.

FIG. 3 illustrates an example client communication process 300 of communicating between sender 102 and client 112 in a unicast routing scheme in accordance with an aspect of the present invention.

After process 300 starts (S302), client 112 must initialize direct communication with server 102 by “punching a hole” through NAT router 114 (S304). In an example embodiment, client 112 sends a UDP registration packet to server 102 via channel 124, NAT router 114 and channel 126. In this example, presume that the UDP hole punch timeout period of NAT router 114 is 45 seconds.

After the hole is punched in NAT router 114, client 112 sends an acknowledgement (Ack) request, e.g., a UDP probe packet, to server 102 (S306). The Ack request additionally acts as a UDP hole punch, thereby resetting the UDP hole punch timeout period of NAT router 114.

As illustrated in FIG. 5, line 502 represents a timeline of actions performed by client 112, whereas line 504 represents a timeline of actions performed by server 102 in client communication process 300. In step S306, at time 508, client 112 sends a first Ack request 506 to server 102. Line 510 represents first Ack request 506 traveling via channel 124, NAT router 114, channel 126 and eventually through channel 116 to server 102.

First Ack request 506 instructs server 102 to send an acknowledgement (Ack) after a predetermined waiting period. In this example, let the predetermined waiting period be zero seconds. Specifically, first Ack request 506 is merely a “hand shake” to establish that a connection has been made between server 102 and client 112.

FIG. 4 illustrates an example server communication process 400 of communicating between sender 102 and client 112 in a unicast routing scheme in accordance with an aspect of the present invention.

After process 400 starts (S402), server 102 receives an Ack request from client 112 (S404). Returning back to FIG. 5, server 102 receives first Ack request 506 at time 512. In this example, as first Ack request 506 requests that server 102 provide a zero second delay, server 102 waits zero seconds (S406). At this point, server 102 sends Ack 514 to client 112 (S408). Line 516 represents Ack 514 traveling via channel 116 and eventually to channel 126, through NAT router 114, through channel 124 and to client 112.

Returning back to FIG. 4, once client 112 has sent an Ack request to server 102 (S306), client 112 waits a predetermined timeout period (S308). This predetermined timeout period takes into account the predetermined waiting period that had been requested of server 102 in addition to the travel times represented by lines 510 and 516. In this case, presume that the sum of the travel times represented by lines 510 and 516 is negligible relative to the UDP hole punch timeout period of NAT router 114. Accordingly, the zero second delay that server 102 provided before sending Ack 514 enables Ack 514 to pass through the punched hole in NAT router 114 prior to the expiration of the UDP hole punch timeout period of NAT router 114.

After client 112 waits the predetermined timeout period, it is determined whether an Ack is received from server 102 (S310). Because Ack 514 passes through the punched hole in NAT router 114 prior to the expiration of the UDP hole punch timeout period of NAT router 114, client 112 receives Ack 514.

It is then determined whether Ack 514 is the first Ack from server 102 (S312). As Ack 514 is the first Ack from server 102, client 112 determines the IP address of server 102 from data within Ack 514 (S314). This determination may be performed by any known method, a non-limiting example of which includes reading source IP address information within a header portion of Ack 514.

A new timeout period is now determined (S316). As discussed above, the predetermined timeout period takes into account the predetermined waiting period that will requested of server 102 in addition to the travel times to and from server 102. In an example embodiment, let the new timeout period take into account a 10 second predetermined waiting period that will be requested of server 102.

Now that the new timeout period has been determined, client 112 sends a new Ack request to server 102 (S306). Again, the new Ack request additionally acts as a UDP hole punch, thereby resetting the UDP hole punch timeout period of NAT router 114.

Returning to FIG. 5, in step S306, at time 518, client 112 sends a second Ack request 520 to server 102. Line 522 represents second Ack request 520 traveling via channel 124, NAT router 114, channel 126 and eventually through channel 116 to server 102.

Second Ack request 520 instructs server 102 to send an Ack after a predetermined waiting period of 10 seconds.

Server 102 receives second Ack request 520 at time 524. In this example, as second Ack request 520 requests that server 102 provide a 10 second delay, server 102 waits 10 seconds (S406). At time 528, server 102 sends Ack 526 to client 112 (S408). Line 530 represents Ack 526 traveling via channel 116 and eventually to channel 126, through NAT router 114, through channel 124 and to client 112.

Returning back to FIG. 4, once client 112 has sent an Ack request to server 102 (S306), client 112 waits the predetermined timeout period (S308). This predetermined timeout period takes into account the predetermined waiting period of 10 seconds that had been requested of server 102, in addition to the travel times represented by lines 522 and 530. In this case, presume that the sum of the travel times represented by lines 522 and 530 is negligible relative to the UDP hole punch timeout period of NAT router 114. Accordingly, the 10 second delay that server 102 provided before sending Ack 526 enables Ack 526 to pass through the punched hole in NAT router 114 prior to the expiration of the UDP hole punch timeout period of NAT router 114.

After client 112 waits the predetermined timeout period, it is determined whether an Ack is received from server 102 (S310). Because Ack 526 passes through the punched hole in NAT router 114 prior to the expiration of the UDP hole punch timeout period of NAT router 114, client 112 receives Ack 526.

It is then determined whether Ack 526 is the first Ack from server 102 (S312). As Ack 526 is not the first Ack from server 102, client 112 then determines whether the IP address of server 102 has changed (S318). For example, the source IP address information within a header portion of Ack 526 may be read and compared with the remembered IP address from step S314.

If the IP address information within a header portion of Ack 526 matches the IP address information within a header portion of Ack 514, it would indicate to client 112, that Ack 514 traveled along a different route than Ack 526. This would therefore indicate that the UDP hole punch timeout period of NAT router 114 had expired (S320).

In this case, presume that the IP address information within a header portion of Ack 526 matches the IP address information within a header portion of Ack 514. As such, it is determined that there is no change in the IP address and a new timeout period is set (S316).

As discussed above, the predetermined timeout period takes into account the predetermined waiting period that will requested of server 102 in addition to the travel times to and from server 102. In an example embodiment, let the new timeout period take into account a 30 second predetermined waiting period that will be requested of server 102.

Now that the new timeout period has been determined, client 112 sends a new Ack request to server 102 (S306). Again, the new Ack request additionally acts as a UDP hole punch, thereby resetting the UDP hole punch timeout period of NAT router 114.

Returning to FIG. 5, in step S306, at time 532, client 112 sends a third Ack request 534 to server 102. Line 536 represents third Ack request 534 traveling via channel 124, NAT router 114, channel 126 and eventually through channel 116 to server 102.

Third Ack request 534 instructs server 102 to send an Ack after a predetermined waiting period of 30 seconds.

Server 102 receives third Ack request 534 at time 538. In this example, as third Ack request 534 requests that server 102 provide a 30 second delay, server 102 waits 30 seconds (S406). At time 542, server 102 sends Ack 540 to client 112 (S408). Line 544 represents Ack 540 traveling via channel 116 and eventually to channel 126, through NAT router 114, through channel 124 and to client 112.

Returning back to FIG. 4, once client 112 has sent an Ack request to server 102 (S306), client 112 waits the predetermined timeout period (S308). This predetermined timeout period takes into account the predetermined waiting period of 30 seconds that had been requested of server 102, in addition to the travel times represented by lines 536 and 544. In this case, presume that the sum of the travel times represented by lines 536 and 544 is negligible relative to the UDP hole punch timeout period of NAT router 114. Accordingly, the 30 second delay that server 102 provided before sending Ack 540 enables Ack 540 to pass through the punched hole in NAT router 114 prior to the expiration of the UDP hole punch timeout period of NAT router 114.

After client 112 waits the predetermined timeout period, it is determined whether an Ack is received from server 102 (S310). Because Ack 540 passes through the punched hole in NAT router 114 prior to the expiration of the UDP hole punch timeout period of NAT router 114, client 112 receives Ack 540.

It is then determined whether Ack 540 is the first Ack from server 102 (S312). As Ack 540 is not the first Ack from server 102, client 112 then determines whether the IP address of server 102 has changed (S318). For example, the source IP address information within a header portion of Ack 540 may be read and compared with the remembered IP address from step S314. In this case, presume that the IP address information within a header portion of Ack 540 matches the IP address information within a header portion of Ack 514. As such, it is determined that there is no change in the IP address and a new timeout period is set (S316).

As discussed above, the predetermined timeout period takes into account the predetermined waiting period that will requested of server 102 in addition to the travel times to and from server 102. In an example embodiment, let the new timeout period take into account a 60 second predetermined waiting period that will be requested of server 102.

Now that the new timeout period has been determined, client 112 sends a new Ack request to server 102 (S306). Again, the new Ack request additionally acts as a UDP hole punch, thereby resetting the UDP hole punch timeout period of NAT router 114.

Returning to FIG. 5, in step S306, at time 546, client 112 sends a fourth Ack request 548 to server 102. Line 550 represents fourth Ack request 548 traveling via channel 124, NAT router 114, channel 126 and eventually through channel 116 to server 102.

Fourth Ack request 548 instructs server 102 to send an Ack after a predetermined waiting period of 60 seconds.

Server 102 receives fourth Ack request 548 at time 552. In this example, as fourth Ack request 548 requests that server 102 provide a 60 second delay, server 102 waits 60 seconds (S406). At time 560, server 102 sends Ack 554 to client 112 (S408). Line 562 represents Ack 554 traveling via channel 116 and eventually to channel 126 and to NAT router 114.

Returning back to FIG. 4, once client 112 has sent an Ack request to server 102 (S306), client 112 waits the predetermined timeout period (S308). This predetermined timeout period takes into account the predetermined waiting period of 60 seconds that had been requested of server 102, in addition to the travel times represented by line 550 and a line approximately equal to any one of lines 516, 530 or 544. Specifically, in this case, line 562 does not extend to the client. In this case, presume that the sum of the travel times represented by line 536 and any one of lines 516, 530 or 544 is negligible relative to the UDP hole punch timeout period of NAT router 114. Accordingly, the 60 second delay that server 102 provided before sending Ack 554 is longer than the 45 second UDP hole punch timeout period of NAT router 114. Accordingly, Ack 554 does not pass through the punched hole in NAT router 114 prior to the expiration of the UDP hole punch timeout period of NAT router 114.

After client 112 waits the predetermined timeout period, it is determined whether an Ack is received from server 102 (S310). Because Ack 554 did not pass through the punched hole in NAT router 114 prior to the expiration of the UDP hole punch timeout period of NAT router 114, client 112 does not receive Ack 554.

At this point, client 112 completes the discovery UDP hole punch timeout period of NAT router 114 (S320). Specifically, client 112 now knows that the UDP hole punch timeout period of NAT router 114 is less than 60 seconds. Further, based on the last successful Ack reception, i.e., the reception of Ack 540, client 112 can determine that the UDP hole punch timeout period of NAT router 114 is at least longer than 30 seconds.

Client 112 may not need to determine the exact UDP hole punch timeout period of NAT router 114, which in this example is 45 seconds. However, knowing that the UDP hole punch timeout period of NAT router 114 is at least longer than 30 seconds, client 112 may now only send a KEEP ALIVE message every 30 seconds. Without using a UDP hole punch timeout period discovery method in accordance with an aspect of the present invention, a client 112 way resort to sending KEEP ALIVE message at much shorter intervals, such as every 10 seconds, to ensure that the unknown UDP hole punch timeout period of NAT router 114 does not expire.

Once the UDP hole punch timeout period of NAT router 114 is discovered, process 300 stops (S322).

In the example embodiments discussed above, the initial timeout period is set as 10 seconds. However, other embodiments may use different timeout periods. Further, in the example embodiments discussed above, the second timeout period is set for 30 seconds and the third timeout period is set for 60 seconds. In accordance with the present invention, other incremental increases of a timeout period may be used.

In the example embodiments discussed above, the UDP hole punch timeout discovery process uses the last timeout period, in which an Ack was received from the server, as the UDP hole punch timeout time period. However, other embodiments in accordance with the present invention may continued to more precisely determine an actual UDP hole punch timeout time period.

For example, in the embodiments discussed above, the example was used wherein the UDP hole punch timeout period was 45 seconds. In the examples discussed above with reference to FIGS. 3-5, it was determined that a time period of 30 seconds was within the (unknown from the perspective of client 112) UDP hole punch timeout period of NAT 114, whereas a time period of 60 seconds was not within the UDP hole punch timeout period of NAT 114. To more precisely determine the UDP hole punch timeout period of NAT 114, other embodiments in accordance with the present invention may restart a process, wherein the first Ack request has a timeout period that is more than 30 seconds and less than 60 seconds. This process may be repeated until a more precise UDP hole punch timeout period of NAT 114 is determined.

A client may be a hardware device specifically designed for communication with a server through a network address translation device in accordance with the present invention. The device may comprise a plurality of portions, each operable to perform a different function. For example, a client may be a device including a first portion, a second portion a third portion and a fourth portion. The first portion may be arranged in communication with channel 124 and operable to perform a universal datagram protocol hole punch through NAT router 114 to connect channel 124 and channel 126. The second portion may be operable to send an Ack request to server 102, via NAT router 114. The third portion may be operable to receive the Ack from server 102. The fourth portion may be operable to determine whether the third portion receives the Ack. Alternatively, the device may be unitary and operable to perform all the functions as a single element.

Further, a client may be computer that runs on a software product that enables the computer to communicate with a server through a network address translation device in accordance with the present invention. In other words, in accordance with an aspect of the invention, a computer-readable media may have computer-readable instructions stored thereon, wherein the computer-readable instructions are capable of instructing a computer to perform the processes in accordance with the present invention.

As discussed previously, in accordance with a conventional process of performing an unicast routing scheme, a KEEP ALIVE message is sent through a network address translation device to keep open a UDP punched hole. This conventional method is inefficient. On the contrary, in accordance with an aspect of the present invention, a UDP hole punch timeout period of a network address translation device may be determines. At this point, in accordance with the present invention, the period of sending KEEP ALIVE messages may be based on the determined UDP hole punch timeout period, which may be significantly longer than the conventional period of sending KEEP Alive messages, and thus may be significantly more efficient than the conventional process.

The foregoing description of various preferred embodiments of the invention have been presented for purposes of illustration and description. It is not intended to be exhaustive or to limit the invention to the precise forms disclosed, and obviously many modifications and variations are possible in light of the above teaching. The exemplary embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. A method of communicating between a server and a client via a network address translator having a universal protocol hole punch timeout period, the server being in communication with the network address translator via a first channel, the client being in communication with the network address translator via a second channel, said method comprising:
performing a universal datagram protocol hole punch through the network address translator to connect the first channel and the second channel;
sending, from the client, an acknowledgment request including information based on a predetermined period of time;
receiving, at the server, the acknowledgment request; and
sending, from the server and after delaying for the predetermined period of time, an acknowledgment based on the acknowledgment request.

2. The method of claim 1, further comprising:
receiving, at the client, the acknowledgement; and
sending, from the client, a second acknowledgment request including information based on a second predetermined period of time, wherein the second predetermined period of time is greater than the predetermined period of time.

3. The method of claim 2, further comprising:
receiving, at the server, the second acknowledgment request; and
sending, from the server and after delaying for the second predetermined period of time, a second acknowledgment based on the second acknowledgment request.

4. The method of claim 1, further comprising determining whether the client receives the acknowledgment.

5. The method of claim 4, further comprising determining that the universal protocol hole punch timeout period of the network address translator is less than the predetermined period of time when it is determined that the client does not receive the acknowledgement.

6. The method of claim 5, further comprising determining that the universal protocol hole punch timeout period of the network address translator is greater than or equal to the predetermined period of time when it is determined that the client does receive the acknowledgement.

7. The method of claim 4, further comprising determining that the universal protocol hole punch timeout period of the network address translator is greater than or equal to the predetermined period of time when it is determined that the client does receive the acknowledgement.

8. The method of claim 4, further comprising determining whether the acknowledgement is a first acknowledgement from the server when it is determined that the client does receive the acknowledgement.

9. The method of claim 8, further comprising determining an internet protocol address of the server based on the acknowledgement when it is determined that the acknowledgement is a first acknowledgement from the server.

10. The method of claim 8, further comprising determining whether an internet protocol address of the server is different than a previously known internet protocol address of the server when it is determined that the acknowledgement is not a first acknowledgement from the server.

11. A device for use with a server and a network address translator having a universal protocol hole punch timeout period, the server being in communication with the network address translator via a first channel, the network address being additionally in communication with a second channel, said device comprising:
a first portion in communication with the second channel and being operable to perform a universal datagram protocol hole punch through the network address translator to connect the first channel and the second channel; and
a second portion operable to send an acknowledgment request to the server, via the network address translator,
wherein the acknowledgment request includes information capable of instructing the server to send an acknowledgment after a predetermined period of time.

12. The device of claim 11, further comprising:
a third portion operable to receive the acknowledgement from the server,
wherein said second portion is further operable to send a second acknowledgment request to the server, via the network address translator, and
wherein the second acknowledgement request includes information capable of instructing the server to send a second acknowledgment after a second predetermined period of time,
wherein the second predetermined period of time is greater than the predetermined period of time.

13. The device of claim 12, further comprising a fourth portion operable to determine whether said third portion receives the acknowledgment.

14. The device of claim 13, wherein said fourth portion is further operable to determine that the universal protocol hole punch timeout period of the network address translator is less than the predetermined period of time when it is determined that said third portion does not receive the acknowledgement.

15. The device of claim 14, wherein said fourth portion is further operable to determine that the universal protocol hole punch timeout period of the network address translator is greater than or equal to the predetermined period of time when it is determined that said third portion does receive the acknowledgement.

16. The device of claim 13, wherein said fourth portion is further operable to determine that the universal protocol hole punch timeout period of the network address translator is greater than or equal to the predetermined period of time when it is determined that said third portion does receive the acknowledgement.

17. A computer-readable medium for use with a computer that is operable to communicate with a server via a network address translator having a universal protocol hole punch timeout period, the server being in communication with the network address translator via a first channel, the computer being in communication with the network address translator via a second channel, said computer-readable medium including instructions operable to instruct the computer to perform the method comprising:
performing a universal datagram protocol hole punch through the network address translator to connect the first channel and the second channel;
sending, from the computer, an acknowledgment request including information based on a predetermined period of time;
receiving, at the server, the acknowledgment request; and
sending, from the server and after delaying for the predetermined period of time, an acknowledgment based on the acknowledgment request.
